(19) United States
(12) Patent Application Publication
(10) Pub. No.: US 2009/0096196 A1
(43) Pub. Date: Apr. 16, 2009

(54) Airbag module

(75) Inventors: Thomas Lube, Berlin (DE); Andreas Pradel, Berlin (DE); Marc Prost-Fin, Berlin (DE)

Correspondence Address: FOLEY AND LARDNER LLP;SUITE 500, 3000 K STREET NW, WASHINGTON, DC, 20007, US

(73) Assignee: TAKATA-PETRI AG

(21) Appl. No.: 12/285,122

(22) Filed: Sep. 29, 2008

Related U.S. Application Data
(63) Continuation of application No. PCT/DE2007/000472, filed on Mar. 8, 2007.

(30) Foreign Application Priority Data
Mar. 30, 2006 (DE) 10 2006 015 315.4

(51) Int. Cl. B60R 21/26; B60R 21/217

(52) U.S. Cl. 280/729; 280/736

(57) ABSTRACT

An airbag module includes an airbag, a gas generator, and a module including at least one outflow opening. Gas generated by the gas generator enters an exterior space surrounding the airbag module through outflow opening. The airbag module also includes a movable first element that is assigned to the outflow opening and can be moved from an initial position, in which the first element closes the outflow opening into an end position. Movement of the first element out of the initial position into the end position causes the outflow opening to be opened. The at least one outflow opening is assigned a second element that may be moved out of an initial position into an end position in order to close the open outflow opening.

### CROSS-REFERENCE TO RELATED APPLICATIONS

This application is a Continuation of International Application No. PCT/DE2007/000472, filed Mar. 8, 2007, which was published in German as WO 2007/115519. The foregoing application is incorporated by reference herein in its entirety.

### BACKGROUND

The present application relates generally to an airbag module for a motor vehicle. Airbag modules generally comprise an airbag which can be inflated to protect an occupant. Gasses are generated by a gas generator and pass an opening into the airbag.

It would be advantageous to provide a mechanism to vary the inflation behavior of the airbag module.

### SUMMARY

One disclosed embodiment relates to an airbag module for a motor vehicle. The airbag module includes an airbag that can be inflated with gas to protect an occupant, a gas generator with which gas for inflating the airbag can be released, a module housing at least partially surrounding the gas generator, and at least one outflow opening that is provided on the module housing. Gas generated by the gas generator can enter an exterior space surrounding the airbag module through outflow opening. The airbag module further includes a movable first element that is assigned to the outflow opening and can be moved from an initial position, in which the first element closes the outflow opening into an end position. Movement of the first element out of the initial position into the end position causes the outflow opening to be opened such that the gas generated by the gas generator is at least partially conducted through the outflow opening into the exterior space. The at least one outflow opening is assigned a second element that may be moved out of an initial position into an end position in order to close the open outflow opening.

Another embodiment relates to an airbag module for a motor vehicle. The airbag module includes an airbag that can be inflated with gas to protect an occupant, a gas generator for releasing gas for inflating the airbag, a module housing surrounding the gas generator, and at least one through-flow opening that is provided on the module housing. The at least one through-flow opening can be in fluid communication with the airbag such that gas generated by the gas generator can pass through the through-flow opening into the airbag. The module further includes at least one outflow opening that is provided on the module housing, and through which gas generated by the gas generator can enter an exterior space surrounding the airbag module; and a movable first element that is assigned to the outflow opening and can be moved from an initial position, in which the first element closes the outflow opening into an end position. Movement of the first element out of the initial position into the end position causes the outflow opening to be opened such that the gas generated by the gas generator is at least partially conducted through the outflow opening into the exterior space. The at least one through-flow opening is assigned a second element that can be moved out of an initial position in which the through-flow opening is open, into an end position, the movement of the second element out of the initial position into the end position causing the through-flow opening to be closed such that gas generated by the gas generator cannot pass through the through-flow opening into the airbag.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a perspective exploded view of an airbag module, with a first and a second movable element for opening and closing an outflow opening of the airbag module.

FIG. 2 is a perspective view showing a flat wall part of the airbag module shown in FIG. 1, with the first element which is mounted displaceably thereon and the second element which is mounted displaceably thereon for opening and closing outflow openings of the wall part.

FIGS. 3A-3B are isometric views showing opposite sides of the wall part shown in FIG. 2, with the movable elements in a specific position with regard to the outflow openings on the wall part.

FIGS. 4A-4B are isometric views showing opposite sides of the wall part shown in FIG. 2, with the movable elements in a specific position with regard to the outflow openings on the wall part.

FIGS. 5A-5B are isometric views showing opposite sides of the wall part shown in FIG. 2, with the movable elements in a specific position with regard to the outflow openings on the wall part.

FIG. 6 is a perspective exploded view of a modification of the airbag module shown in FIG. 1.

FIG. 7 is a perspective view showing a curved wall part of the airbag module shown in FIG. 6, with the first element which is mounted displaceably thereon and the second element which is mounted displaceably thereon for opening and closing outflow openings of the curved wall part.

FIGS. 8A-8B are perspective views showing the curved wall part shown in FIG. 7, with the movable elements in a specific position with regard to the outflow openings on the wall part.

FIGS. 9A-9B are perspective views showing the curved wall part shown in FIG. 7, with the movable elements in a specific position with regard to the outflow openings on the wall part.

FIGS. 10A-10B are perspective views showing the curved wall part shown in FIG. 7, with the movable elements in a specific position with regard to the outflow openings on the wall part.

FIG. 11 is a perspective exploded view of a further modification of the airbag module shown in FIGS. 1 and 6.

FIG. 12 is a perspective view showing a curved wall part of the airbag module shown in FIG. 11, with the first element mounted displaceably thereon.

FIGS. 13A-13B are perspective views showing the curved wall part shown in FIG. 12 with different positions of the movable first element.

FIGS. 14A-14B are perspective views showing a curved further wall part of the airbag module shown in FIG. 11, with the second element mounted displaceably thereon in different positions.

### DETAILED DESCRIPTION

One disclosed embodiment relates to an airbag module for a motor vehicle. Airbag modules are typically provided in vehicles to protect vehicle occupants in a vehicle collision. The airbag module includes an airbag that can be inflated with gas to protect an occupant, a gas generator for releasing a gas for inflating the airbag, a module housing at least partially surrounding the gas generator, and at least one outflow opening that is provided on the module housing. Gas generated by the gas generator can enter an exterior space surrounding the airbag module through outflow opening. The airbag module further includes a movable first element that is assigned to the outflow opening and can be moved from an initial position, in which the first element closes the outflow opening into an end position. Movement of the first element out of the initial position into the end position causes the outflow opening to be opened such that the gas generated by the gas generator is at least partially conducted through the outflow opening into the exterior space. The at least one outflow opening is assigned a second element that may be moved out of an initial position into an end position in order to close the open outflow opening.

Another embodiment relates to an airbag module for a motor vehicle. The airbag module includes an airbag that can be inflated with gas to protect an occupant, a gas generator for releasing gas for inflating the airbag, a module housing surrounding the gas generator, and at least one through-flow opening that is provided on the module housing. The at least one through-flow opening can be in fluid communication with the airbag such that gas generated by the gas generator can pass through the through-flow opening into the airbag. The module further includes at least one outflow opening that is provided on the module housing, and through which gas generated by the gas generator can enter an exterior space surrounding the airbag module; and a movable first element that is assigned to the outflow opening and can be moved from an initial position, in which the first element closes the outflow opening into an end position. Movement of the first element out of the initial position into the end position causes the outflow opening to be opened such that the gas generated by the gas generator is at least partially conducted through the outflow opening into the exterior space. The at least one through-flow opening is assigned a second element that can be moved out of an initial position in which the through-flow opening is open, into an end position, the movement of the second element out of the initial position into the end position causing the through-flow opening to be closed such that gas generated by the gas generator cannot pass through the through-flow opening into the airbag.

The above measures give rise to the option of opening and of closing the outflow opening or through-flow opening as a function of a particular accident situation and an occupant (occupant weight, height) such that a quantity of gas with which the airbag has been or is filled can be adapted more exactly to the particular accident situation. For example, in the case of an out-of-position situation (OOP situation), i.e. the airbag is blocked at an early point, the outflow opening can therefore be opened at an early point (and additionally the through-flow opening closed) such that the person to be protected is not injured by an airbag which is inflated too violently.

The restraint performance of an airbag module concept of this type is adapted via an opening and closing time of the outflow opening or through-flow opening. As the time constitutes a simply controllable parameter of software used for controlling the outflow opening or through-flow opening, an airbag module of this type can easily be adapted to very different requirements.

The movable first element is preferably mounted on the module housing, to be precise so that it can be displaced linearly in a first direction of movement out of its initial position into its end position. The movable second element is preferably likewise mounted on the module housing so that it can be displaced linearly in a second direction of movement out of its initial position into its end position, wherein the first direction of movement is preferably oriented in an opposed manner to the second direction of movement.

According to one exemplary embodiment, the two movable elements are planar slides that can preferably be moved independently of each other such that, in particular, the movement of the first element out of its initial position into its end position leaves a closed or an open state of the through-flow opening unchanged, and that the movement of the second element out of its initial position into its end position leaves a closed or open state of the outflow opening unchanged. If appropriate, the outflow opening and the through-flow opening therefore can be advantageously opened or closed completely independently of each other.

According to one exemplary embodiment, the two elements may open the outflow opening for a predeterminable period of time (from an opening time to a closing time) to vent the airbag in a controlled (time-controlled) manner. The two movable elements each have at least one passage opening, wherein, in the initial position of the first element, the at least one passage opening of the first element is arranged such that it does not overlap with the at least one outflow opening. The at least one outflow opening and the corresponding passage opening are displaced in relation to each other so that a region of the first element that is arranged adjacent to the passage opening covers the at least one outflow opening and, in the process, closes it (in this case the closed outflow opening is not fully gas-tight).

When the second element is in an initial position, the at least one passage opening of the second element at least partially overlaps with the corresponding at least one outflow opening, allowing gas to escape out of the module housing through the outflow opening and the one passage opening unless the first element in its initial position covers the outflow opening. According to preferred embodiment, the at least one passage opening of the second element completely overlaps with the corresponding at least one outflow opening.

In order to open the outflow opening during the inflation of the airbag, the first element therefore is moved out of its initial position into its end position such that the passage opening of the first element is brought to overlap with the outflow opening. Since the second element is initially in its above-described initial position, the outflow opening is thereby opened.

For the possibly subsequent closing of the outflow opening, the second element is moved out of its initial position into its end position, with its passage opening moving such that it does not overlap with the outflow opening, and therefore the outflow opening is closed by the second element which is in its end position.

In the present case, bringing two openings such that they overlap does not mean that two openings under consideration (i.e., the passage opening of the first element and the corresponding outflow opening of the module housing are arranged congruently) with the same contour and surface, but rather merely that the first element which is mounted movably on the module housing is displaced toward the module housing so that its passage opening comes at least partially to lie above the outflow opening such that the two openings are connected to each other in a gas-conducting manner.

However, the two passage openings are preferably formed congruently with the corresponding outflow opening, i.e. they have the same contours and opening cross sections.

Furthermore, the full open outflow opening (or an entirety of such openings) preferably has an opening cross section of 4000 mm2 to 5000 mm2, through which gas can escape from the module housing into the surrounding exterior space.

In an alternative embodiment, the movable first element opens or closes the at least one outflow opening while the second movable element opens or closes the through-flow opening through which the gas generator arranged in the module housing can be in fluid communication with the airbag. Before the airbag is inflated, the first and second element are preferably initially in their respective initial position. In this case, the first element is mounted on the module housing so that, in the initial position, the passage opening of the first element does not overlap with the outflow opening and the first element covers and closes the outflow opening. By contrast, in its initial position, the second element is arranged such that the passage opening of the second element overlaps with the through-flow opening such that gas generated by the gas generator may be conducted through the through-flow opening into the airbag. When the second element moves out of its initial position into its end position, the passage opening does not overlap with the through-flow opening in order to close the through-flow opening.

The outflow opening is preferably provided in a wall part of the module housing, which wall part is preferably fixed releasably to the module housing, wherein the first element is mounted on the wall part so that it can be displaced toward the wall part in order to bring the passage opening such that it overlaps with or does not overlap with the outflow opening. As an alternative to the releasable connection between wall part and module housing, the wall part is preferably formed integrally with the module housing.

In one alternative, the wall part is an insert, with the wall part having two edge regions which lie opposite each other transversely with respect to the first direction of movement and which, in order to releasably fasten the wall part to the module housing, each engage in a groove, with the two grooves being formed on the module housing.

The first element is preferably mounted in a longitudinally displaceable manner on an inner side of the wall part, which inner side faces an interior space which is enclosed by the module housing, with it being possible for the first element to slide along the inner side of the wall part. In this case, the first element is preferably guided in rails which are provided on the inner side. Such rails are preferably formed integrally with the wall part.

In one embodiment, the second movable element is likewise mounted in a longitudinally displaceable manner on the wall part, the second element preferably being mounted displaceably on an outer side of the wall part, which outer side faces away from the inner side of the wall part, i.e. the wall part is arranged transversely with respect to the first direction of movement between the two elements which can preferably each be moved out of the particular initial position into the particular end position in opposite directions of movement.

In an alternative embodiment, the second element is mounted displaceably on the inner side of the wall part, the second element being arranged transversely with respect to the first direction of movement between the first element and the wall part.

The module housing preferably has a chamber which at least partially surrounds the gas generator and in particular is of cylindrical design, with the cylinder axis preferably being oriented parallel to the first direction of movement. Two walls protrude—preferably tangentially—from said chamber transversely with respect to the first direction of movement, the two walls lying opposite each other transversely with respect to the main direction of deployment of the airbag. In this case, the main direction of deployment of the airbag is understood as meaning that direction along which the airbag moves upon inflation toward an occupant who is to be protected. In the case of the chamber of cylindrical design, the gas generator is preferably designed as a tubular gas generator which extends longitudinally along the first direction of movement and the longitudinal axis of which coincides with the cylinder axis of the chamber.

According to another embodiment, the wall part is provided on one of the two walls and may be pushed into two grooves by its mutually opposite edge regions for releasable fixing of it to the wall are arranged on the relevant wall. The two grooves run parallel to each other and extend along the first direction of movement. The wall part itself is oriented here so that the at least one outflow opening formed on the wall part enables gases generated by the gas generator to flow off in a direction oriented transversely with respect to the main direction of deployment.

In the event of the wall part being formed on one of the two walls, the first and second movable elements are preferably each designed as a flat slide which—in the same manner as the wall part as a support of the two movable elements—extends in a planar manner along a plane of extent.

According to yet another embodiment, the wall part forms part of the chamber with the wall part facing away from an occupant who is to be protected. The grooves for the releasable fixing of the wall part, which is designed as an insert, may be provided on the chamber and run parallel to each other along the first direction of movement or along the cylinder axis of a chamber formed cylindrically. In particular, the two grooves can also be formed integrally with the chamber.

In the case of a cylindrical chamber, a wall part provided on the chamber, in the same manner as the movable elements mounted thereon, has a convex curvature which corresponds to the curvature of the chamber (cylinder casing) about the cylinder axis.

The airbag module has two retaining elements to couple the airbag module in the motor vehicle. The retaining elements, together with the chamber surrounding the gas generator, form a further chamber of the module housing. This further chamber can be in fluid communication with the chamber via the through-flow opening and can form a receptacle for the deployed airbag.

In order to fasten the airbag to the further chamber, the two walls each have an edge which faces away from the chamber, extends along the one chamber (or cylinder axis) and on which a respective fastening region for the airbag is formed.

The airbag can be inflated via an inflow opening with gases that are generated by the gas generator and furthermore has a fixing ring which encircles the inflow opening and can be brought into engagement with the fastening regions of the further chamber in order to fasten the airbag to the module housing. The fastening regions, for example, can each form a groove into which corresponding regions of the fixing ring can be pushed.

The second movable element may be mounted displaceably on a further wall part of the module housing, with the at least one through-flow opening being formed on the further wall part. The further wall part is preferably fixed releasably to the module housing. According to another exemplary embodiment, the further wall part may be preferably connected integrally to the module housing.

In one variant, the further wall part is an insert, with two edge regions lying opposite each other transversely with respect to the first direction of movement. The edge regions engage in two grooves formed on the module housing and to releasably fix the further wall part to the module housing.

The second element is preferably mounted displaceably on an inner side of the further wall part. The inner side faces an interior space that is surrounded by the module housing, with the further wall part preferably forming part of the chamber. The wall part is arranged along the main direction of deployment of the airbag between the gas generator and the airbag. In this case, the two grooves are each provided on an inner side of the particular wall, such that the two grooves lie opposite each other transversely with respect to the main direction of deployment and face each other.

For the independent movement of the two movable elements, each of the two elements is assigned a movement-generating device that moves the first or second element out of its initial position into its end position. The first or second movement-generating device preferably moves the respective movable element at a predefinable opening or closing time. The predefinable times are calculated by an electronic control unit as a function of at least one occupant- or motor-vehicle-related parameter that can be sensed by a sensor unit (occupant weight, height, position of the occupant with respect to the airbag, speed of the motor vehicle and of the occupant, accident-induced deceleration of the motor vehicle and of the occupant, etc.).

According to one embodiment, the two movement-generating devices, which can be designed as identical parts, operate pyrotechnically. The movement-generating devices may include a piston that can be pressurized and, when pressurized, press against an edge of the first or second element to move the particular movable element out of its initial position into its end position.

According to a preferred embodiment, the two movement-generating devices are formed on the wall part, so that they lie opposite each other along the first direction of movement. The wall part together with the two movement-generating devices and the two elements preferably forms a pre-assemblable lower module. This makes it advantageously possible for other airbag modules also to be retrofitted with a venting mechanism described herein. Furthermore, this considerably simplifies the handling of the venting mechanism (lower module) during servicing.

For the situation in which the first element is provided for opening the outflow opening and the second element for closing the through-flow opening, the first movement-generating device is formed on the wall part whereas the second movement-generating device is formed on the further wall part. The wall part, together with the first movement-generating device and the first element, preferably forms a pre-assemblable first lower module while the further wall part together with the second movement-generating device and the second element preferably forms a pre-assemblable, separate, second lower module. The first and second lower modules may be identical parts to reduce production costs.

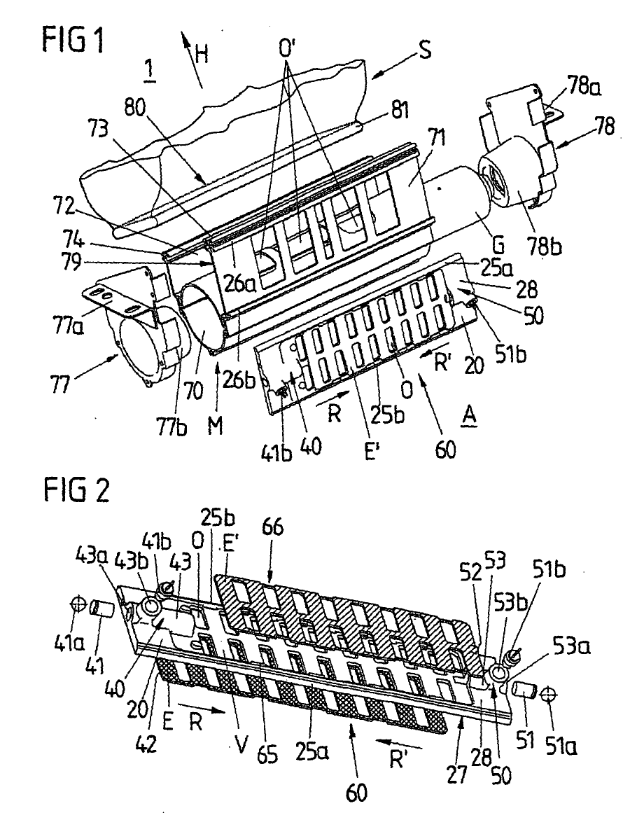

Referring to FIGS. 1 to 5B, an airbag module 1 with an airbag S that can be inflated by a gas generator G is shown according to an exemplary embodiment. The airbag module is shown in FIG. 1 as a passenger airbag module. According to an exemplary embodiment, the gas generator G is a tubular gas generator. The gas generator G is arranged in a chamber 70 of a module housing M that is connected via through-flow openings O′ to a further chamber 79 in which the airbag S is arranged before inflation. The module housing M has a plurality of outflow openings O (only one outflow opening O is indicated by way of example in FIG. 1), that can be opened and closed in a time-controlled manner by a first and second movable element E, E′. The first and second movable elements E, E′ are each driven by a movement-generating device 40, to adapt the gas pressure prevailing in the airbag S to the circumstances of an accident situation (deceleration of the motor vehicle, weight and position of the occupant who is to be protected).

The chamber 70 of the airbag module is generally cylindrical, with the cylinder axis running transversely with respect to a main direction of deployment H of the airbag S. In an installed state of the airbag module 1, the cylinder axis extends substantially along the transverse axis y of the vehicle, in particular parallel to the transverse axis y of the vehicle. The longitudinal axis of the gas generator G arranged in the chamber 70 coincides with the cylinder axis of the chamber 70.

The gas generator G has two free ends that are each clamped by a part 77b, 78b of a retaining element 77, 78 that projects along the cylinder axis into the chamber 70, and therefore the gas generator G is fixed with respect to the chamber 70 which surrounds it. A respective flange 77a, 78a protrudes from the two retaining elements 77, 78 and is configured to fasten the airbag module 1 to a motor vehicle part.

The further chamber 79 of the module housing M is formed by two walls 71, 72 that protrude tangentially from the cylindrical chamber 70 along the main direction of deployment H and by the two retaining elements 77, 78 that partially protrude over the chamber 70 along the main direction of the deployment H. The two walls 71, 72 lie opposite each other transversely with respect to the main direction of deployment H and preferably run parallel to each other.

A respective edge 73, 74 which faces away from the chamber 70 is provided on the two walls 71, 72, the two edges 73, 74 each extending along the cylinder axis of the chamber 70. The two edges 73, 74 are fastening regions for a fixing ring 81 that encircles an inflow opening 80 of the airbag S. The fixing ring 81 can be brought into engagement with the fastening regions 73, 74 to fix the airbag S to the further chamber 79. The two fastening regions 73, 74 are preferably grooves into which the rectangular fixing ring 81 can be pushed.

Gas released in the chamber 70 by the gas generator G, therefore, can pass through the through-flow openings O′ into the further chamber 79 and from there through the inflow opening 80 into the airbag S to inflate the airbag S.

A planar, rectangular (flat) wall part 20 is provided on one of the walls 71 to permit venting of the airbag S upon inflation. The flat all part 20 can be connected releasably to the wall 71. Two grooves 26a and 26b are provided on the wall 71. The grooves run parallel to each other and to the cylinder axis of the chamber 70 and are arranged one above the other along the main direction of deployment. The wall part can be pushed into said grooves 26a, 26b, with corresponding edge regions 25a, 25b of the wall part engaging in the grooves and being guided by them.

The outflow openings O of the module housing M are of rectangular design and are formed in two rows arranged one above the other on a wall part 20.

In its state fixed to the wall 71, the wall part 20 of the exterior space A of the airbag module 1 covers apertures in the wall 71. The apertures are arranged so that the outflow openings O formed in the wall part 20 are arranged in front of said apertures such that, when the outflow openings O are open, gas can be conducted out of the further chamber 79 into the exterior space A of the airbag module 1.

In its installed state, the wall part 20 has an inner side 27 facing an interior space I of the module housing M and an outer side 28 facing away from the inner side 27 (facing the exterior space A).

In order to close the outflow openings O, the second element E′ is mounted displaceably along a second direction of movement R′, which runs parallel to the cylinder axis, on the outer side 28 of the wall part 20. The second element E′ is a planar rectangular member and is received by a depression V of the outer side 28 of the wall part 20. In this case, the second element E′ engages with its two edges extending along the first direction of movement R behind projections 65 which are provided on the wall part 20 (one of said projections is indicated by way of example in FIG. 2) and which firstly ensure that the second element E′ is guided along the first direction of movement R and secondly secure the second element E′ perpendicularly to the outer side 28.

Corresponding recesses 66 are provided on the second element E′ to facilitate the engaging of second element E′ behind the projections 65.

This permits a simple insertion of the second element E′ along a direction oriented perpendicularly to the outer side 28 into the depression V. Upon subsequent displacement of the second element E′ into its initial position counter to the second direction of movement R′, the projections 65 are engaged behind by a respective edge section of the second element E′. In either case, the edge sections are arranged between two recesses 66.

In the same manner, in order to open the outflow opening O, the first element E is mounted displaceably along the first direction of movement R on the inner side 27 of the wall part 20.

The two elements E, E′ have a plurality of passage openings 10, 11 that are configured in respect of number, position and shape (contour and cross-sectional area) such that the passage openings 10, 11 of the two elements E, E′ can each be arranged fully congruently with corresponding outflow openings O of the wall part 20. The outflow openings O of the wall part 20 are generally rectangular and are arranged on the wall part 20 in two rows, with one row above the other, each row extending along the first direction of movement R.

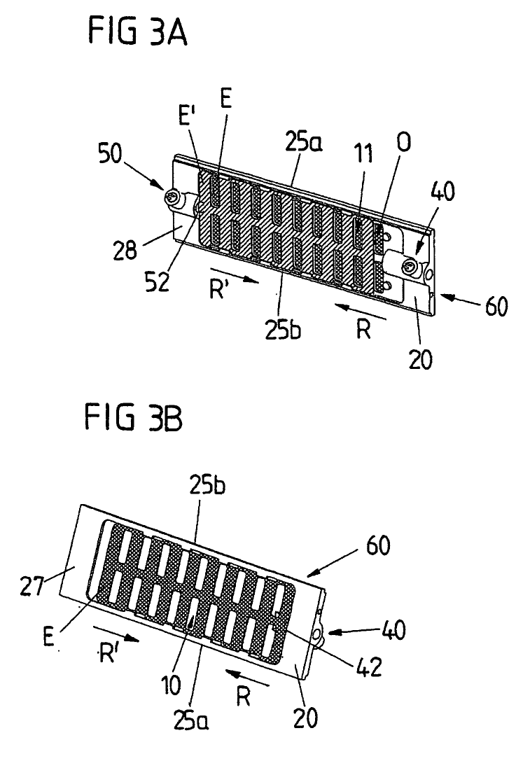

The first element E includes webs that are arranged along the first direction of movement R between in each case two passage openings 10 of the first element E. Prior to inflation, the webs of the first element E covers the outflow openings O. Prior to inflation, the second element E′ is arranged with respect to the wall part 20 so that the passage openings 11 at least partially overlap with the outflow openings O. As a result, the outflow openings O are closed prior to the inflation by the first element E and all of the gas generated by the gas generator G is conducted initially into the airbag S (see FIGS. 3A and 3B).

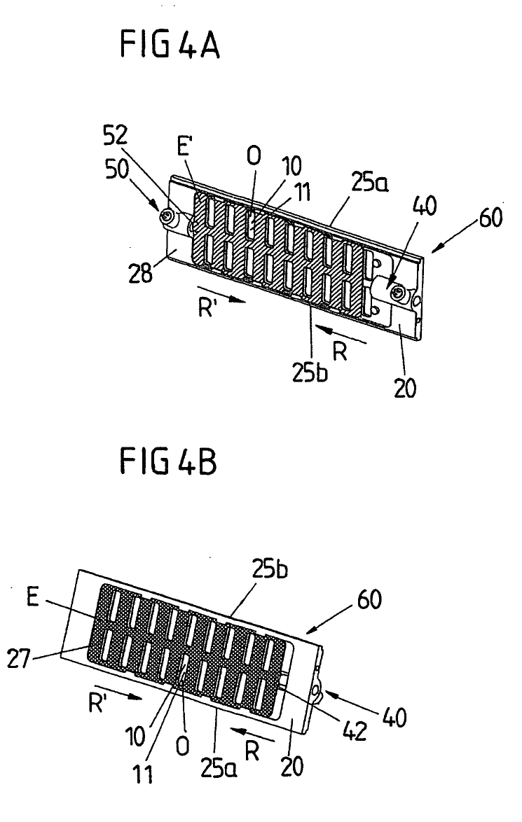

If appropriate, as described above, the outflow openings O may be opened as a function of at least one parameter. All that needs to be done for this is for the first element E to be displaced along the direction of movement R out of its initial position into its end position. The outflow openings O (see FIGS. 4A and 4B) are at least partially opened when the first element E is in its end position and the second element E′ in its initial position.

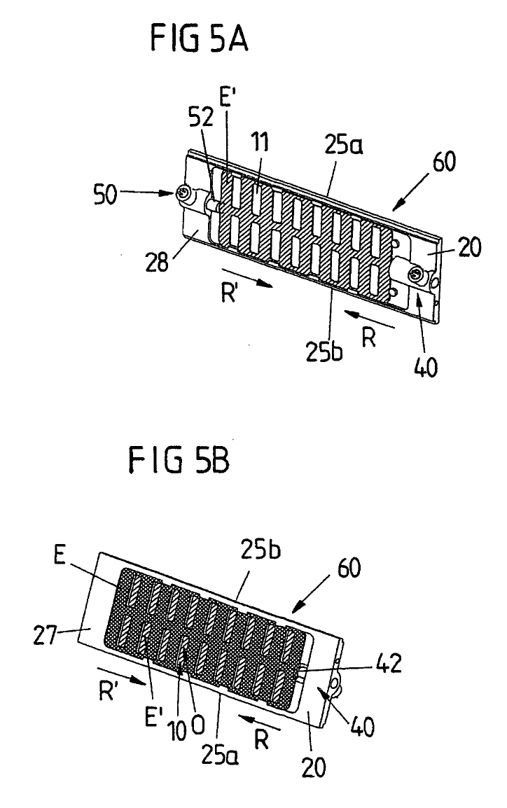

If the outflow openings O are to be closed again as a function of at least one parameter, then the second element E′ is displaced out of its initial position into its end position (e.g., in an opposite direction to the first element E), with the second element E′ in its end position covering the outflow openings O (see FIGS. 5A and 5B).

With this mechanism, the outflow openings O therefore can be opened at a predefinable time for a predefinable period of time in order to bring about controlled venting of the airbag S.

In order to displace the first and second element E, E′, a respective movement-generating device 40, 50 is provided. The two movement-generating devices 40, 50 each have a cylindrical pressure space 43, 53, the two pressure spaces 43, 53 each being arranged on a free edge section of the wall part 20. The edge sections lie opposite each other along the first direction of movement R and are aligned with each other. In the two pressure spaces 43, 53, a respective piston 41, 51 is mounted movably along the first direction of movement R. The pistons 41, 51 are introduced into the respective pressure space 43, 53 through openings 43a, 53a. The two openings 43a, 53a are subsequently closed by a respective spherical closure element 41a, 51a that are pressed into the respective openings 43a, 53a.

In order to drive its piston 41, 51 each movement-generating device 40, 50 has a pyrotechnic gas generator 41b, 51b. The gas generator 41b, 51b is introduced in a sealing manner into a further opening 43b, 53b in the respective pressure chamber 43, 53. A positive pressure is provided in the relevant pressure chamber 43, 53 to push the respective piston 41, 51 out of the pressure chamber 43, 53.

In the case of the first movement-generating device 40, the piston 41 is pressed in the direction of movement R against an edge 42 of the first element E, the edge running transversely with respect to the direction of movement R, such that the first element E is moved in the direction of movement R out of its initial position into its end position. In the case of the second movement-generating device 50, the movement of the second element E′ out of the initial position into the end position takes place in the opposite manner to the first direction of movement R.

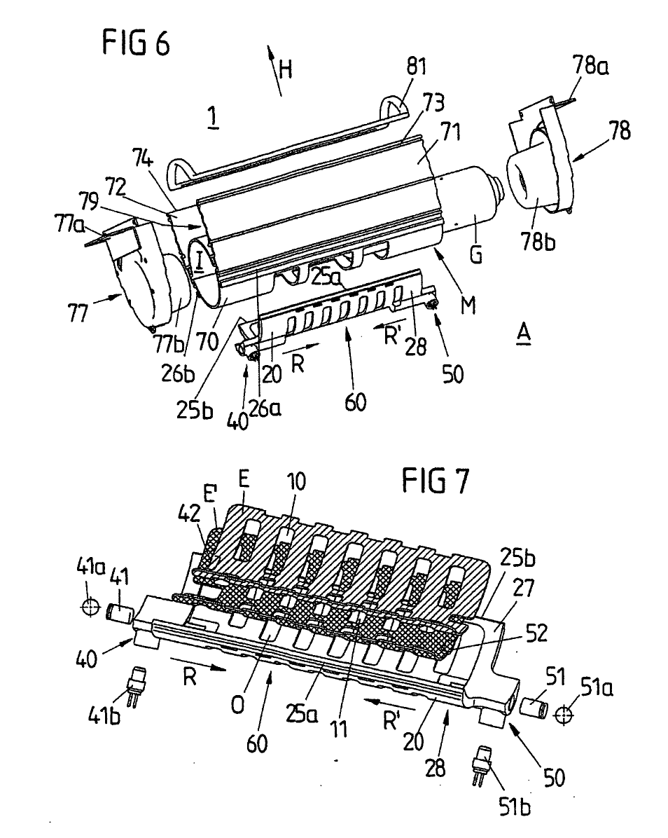

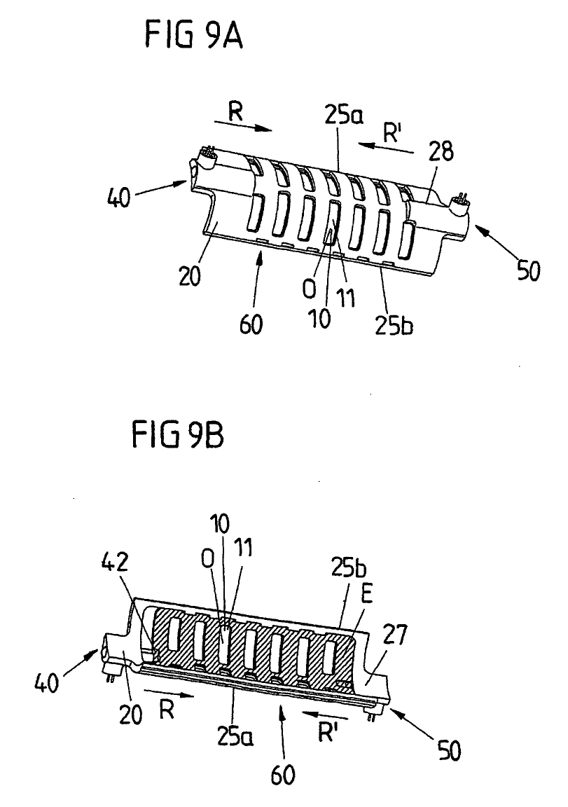

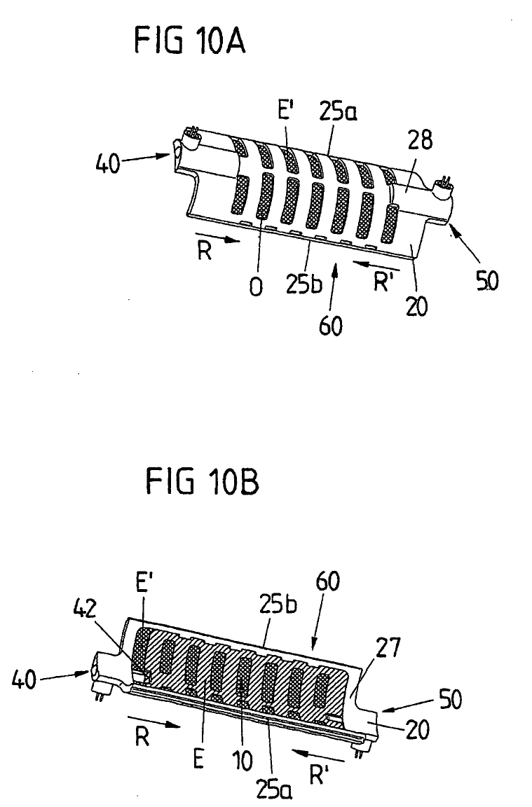

FIGS. 6 to 10B show a modification of the airbag module 1 shown in FIG. 1. In contrast to FIG. 1, the wall part 20 here is not mounted displaceably out of its initial position into its end position on one of the two walls 71, 72 but rather on the chamber 70. According to an exemplary embodiment, the outer side 28 of the wall part 20 faces away from a person who is to be protected.

Furthermore, in contrast to the wall part 20 of FIG. 1, the wall part 20 of FIG. 6 has a convex curvature (e.g., as viewed from the exterior space A) matched to the curvature of the cylindrical chamber 70. Accordingly, the movable elements E, E′ mounted on the wall part 20 also have the identical convex curvature.

Furthermore, the second element E′ is not, as in FIG. 1, mounted on the outer side 28 of the wall part 20, but on the inner side 27 of the wall part 20 (e.g., between the wall part 20 and the first element E).

Accordingly, the depression V, in a direction oriented perpendicularly to the inner side 27, is twice the depth (the depth corresponds to the sum of the thicknesses of the first and second elements E, E′) as in the airbag module 1 shown in FIG. 1.

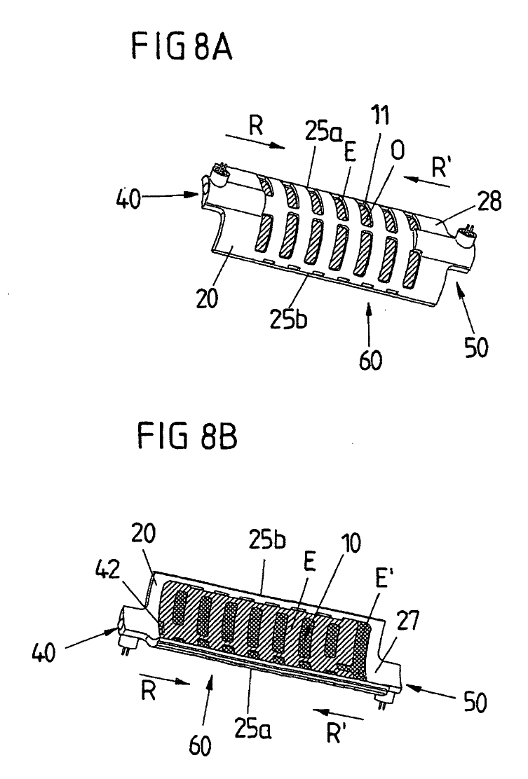

However, the opening or closing of the outflow openings O (see FIGS. 8A to 10B) is analogous to the sequence illustrated in FIGS. 3A to 5B, with the sole difference that the two movable elements E, E′ are mounted movably on the same side of the wall part 20.

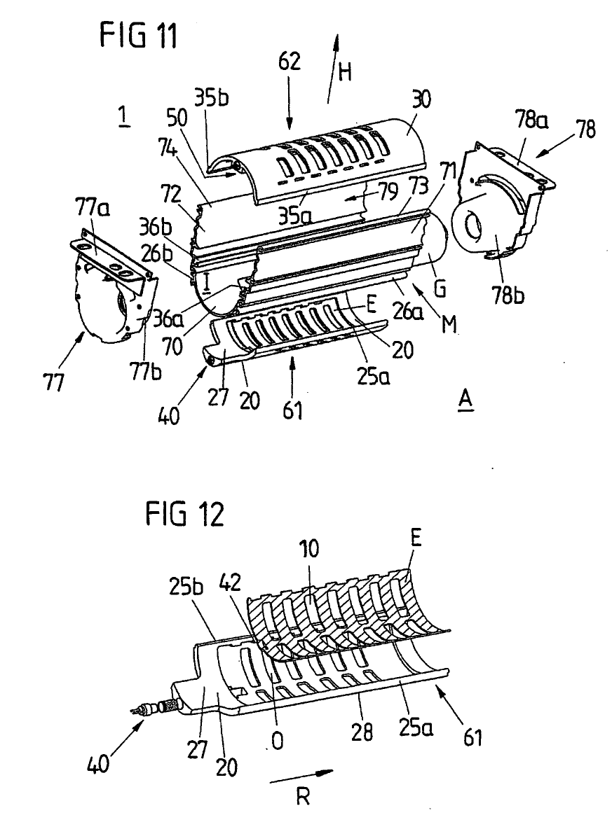

FIG. 11 to 14B show a modification of the airbag module 1, shown in FIG. 6, wherein, in contrast to FIG. 6, only a movable element, namely the first element E, is mounted in a longitudinally displaceable manner on the first wall part 20 on the inner side 27 of the wall part 20. Furthermore, the wall part 20 of FIG. 11 accordingly only has one movement-generating device 40 of the type shown in FIGS. 1 and 6 (see FIG. 12).

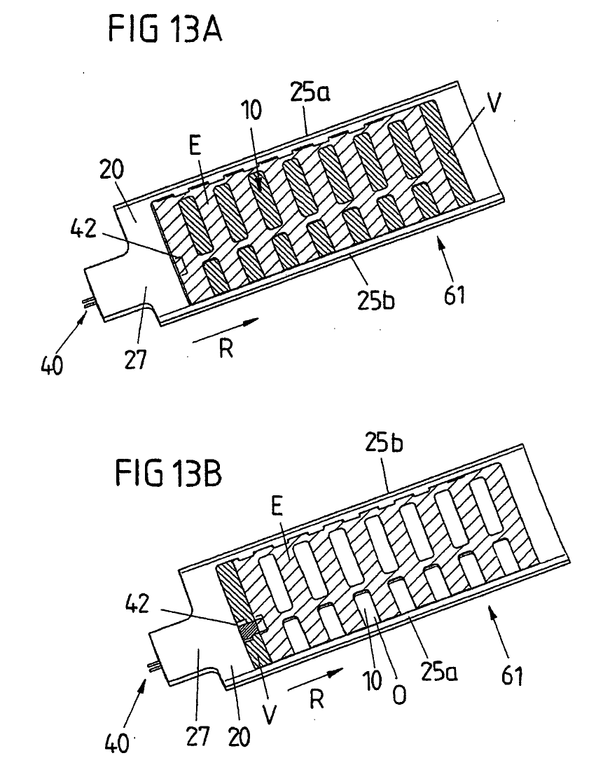

Prior to the inflation of the airbag S, the first element E is in its initial position in which it closes the outflow openings O that are provided on the wall part 20 in the previously described manner (FIG. 13A). Ignition of the movement-generating device 40 causes the first element E to be moved out of its initial position into its end position in which it opens up the outflow openings O according to FIG. 13B in the manner already explained (passage openings 10 are arranged congruently with the outflow openings O).

In the airbag module 1 illustrated in FIG. 11, in order to completely prevent gases from being conducted into the airbag S, the through-flow openings O′ are provided on a further wall part 30 that is arranged between the chamber 70 and the further chamber 79 of the module housing M. The further wall part 30 is constructed substantially identically to the first wall part 20 of FIG. 11 in order to close the through-flow openings O′.

The further wall part 30 has a curvature corresponding to the chamber 70 (convex curvature). The further wall part 30 is an insert that includes two edge regions 35a, 35b lying opposite each other transversely with respect to the cylinder axis of the chamber 70. The further wall part is coupled to the housing M by guiding the two edge regions 35a, 35b into respective grooves 36a, 36b that are formed on mutually facing inner sides of the walls 71, 72.

The two wall parts 20, 30 (as independent lower modules) therefore lie opposite each other along the main direction of deployment H and at least partially engage around the gas generator G in cross section. The second element E′ is mounted movably on the further wall part 30 (e.g., corresponding to the first element E mounted on the wall part 20) in a depression V of an inner side 27 of the further wall part 30, the inner side facing the interior space I. The further wall part 30 therefore forms a partition that can be closed in a controlled manner between the chamber 70 and the further chamber 79.

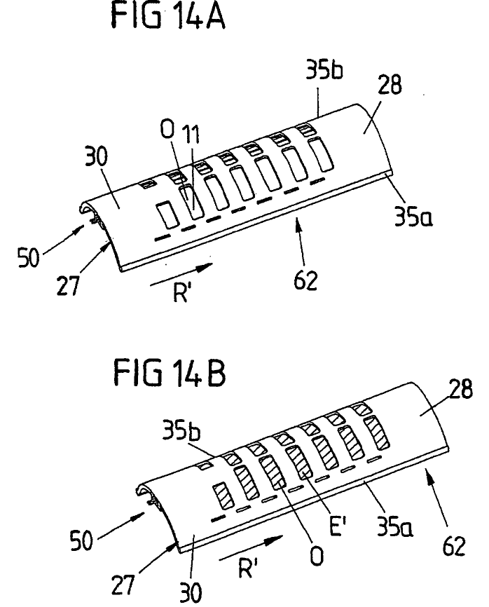

Prior to inflation of the airbag S, the second element E′ of the further wall part 30, in the same manner as the first element E of the wall part 20, is in its initial position (see FIG. 14A) in which the through-flow openings O′ overlap with the passage openings 11 of the second element E′. When the airbag S is inflated, the through-flow openings O′ are therefore opened first (with the outflow openings O closed) such that all the gases generated by the gas generator G pass through the through-flow openings O′ into the further chamber 79 and from there through the inflow opening 80 into the airbag S.

In order to retard the buildup of pressure in the airbag S or to reduce the gas pressure upon inflation of the airbag S, the outflow openings O can now be opened at any desired time (as a rule during the inflation of the airbag S) by the first element E being shot out of its initial position into its end position by the movement-generating device 40.

In addition, the initially open through-flow openings O′ may be closed by movement of the second element E′ (along the second or first direction of movement R′) out of its initial position into its end position according to FIG. 14B (the passage openings 11 of the second element E′ move such that they do not overlap with the through-flow openings O′). The airbag S is thereby completely sealed off such that no further gases can penetrate the airbag.

A particular advantage of the venting mechanisms described in the present case resides firstly in the modular construction (the wall parts 20, 30 together with the movement-generating devices 40, 50 and the movable elements E, E′ form independent pre-assemblable lower modules) and secondly in the relatively large venting cross section which can be obtained by the grid-like arrangement of the outflow openings, discharge openings and passage openings O, O′, 10, 11, with at the same time, high structural stability of the movable elements E, E′.

Furthermore, it is advantageous that the risk of the slides E, E′ blocking during the movement out of the initial position into the end position is low due to the linear movement of the movable elements E, E′ (slides).

Furthermore, it is advantageous that outflow openings and through-flow openings O, O′ are provided that can be controlled by the venting mechanisms described and that act additionally or alternatively to standard outflow openings in an airbag.

The mechanisms described above, i.e. a movement of the first and second elements for controllable opening and closing of the outflow openings and through-flow openings O, O′, can of course also be activated (triggered), as a function of occupant-, crash-relevant (collision-relevant) or vehicle-relevant parameters before or after inflation of the airbag. Such parameters are, for example, the height, mass and position of the occupant to be protected (with respect to the airbag), the speed of the vehicles involved in the collision (or relative speed), and the deceleration of the vehicle during the crash (collision).

The priority application, German Patent Application No. 10 2006 015 315.4, filed Mar. 30, 2006 including the specification, drawings, claims and abstract, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1. An airbag module for a motor vehicle, comprising:
an airbag configured to be inflated with gas to protect an occupant,
a gas generator configured to release gas for inflating the airbag,
a module housing at least partially surrounding the gas generator,
at least one outflow opening that is provided on the module housing, and through which gas generated by the gas generator can enter an exterior space surrounding the airbag module, and
a movable first element that is assigned to the outflow opening and can be moved from an initial position, in which the first element closes the outflow opening into an end position,
wherein movement of the first element out of the initial position into the end position causes the outflow opening to be opened such that the gas generated by the gas generator is at least partially conducted through the outflow opening into the exterior space, and
wherein the at least one outflow opening is assigned a second element that is configured to be moved out of an initial position into an end position in order to close the open outflow opening.

2. An airbag module for a motor vehicle, comprising:
an airbag that can be inflated with gas to protect an occupant,
a gas generator for releasing gas for inflating the airbag,
a module housing surrounding the gas generator,
at least one through-flow opening provided on the module housing and configured to be in fluid communication with the airbag so that gas generated by the gas generator can pass through the through-flow opening into the airbag,
at least one outflow opening which is provided on the module housing, and through which gas generated by the gas generator can enter an exterior space surrounding the airbag module, and
a movable first element that is assigned to the outflow opening and can be moved from an initial position, in which the first element closes the outflow opening into an end position,
wherein movement of the first element out of the initial position into the end position causes the outflow opening to be opened such that the gas generated by the gas generator is at least partially conducted through the outflow opening into the exterior space, and
wherein the at least one through-flow opening is assigned a second element that can be moved out of an initial position in which the through-flow opening is open, into an end position, the movement of the second element out of the initial position into the end position causing the through-flow opening to be closed such that gas generated by the gas generator cannot pass through the through-flow opening into the airbag.

3. The airbag module of claim 1, wherein the first element is mounted on the module housing so that it can be displaced linearly in a first direction of movement out of its initial position into its end position.

4. The airbag module of claim 1, wherein the second element is mounted on the module housing so that it can be displaced linearly in a second direction of movement out of its initial position into its end position.

5. The airbag module of claim 4, wherein the first direction of movement is oriented in an opposed manner to the second direction of movement.

6. (canceled)

7. (canceled)

8. The airbag module of claim 1, wherein the two elements can be moved independently of each other.

9. The airbag module of claim 1, wherein the movement of the first element out of the initial position into the end position leaves a closed or an open state of the through-flow opening unchanged.

10. The airbag module of claim 1, wherein the movement of the second element out of its initial position into its end position leaves a closed or an open state of the outflow opening unchanged.

11. The airbag module of claim 1, wherein the first element has at least one passage opening.

12. The airbag module of claim 1, wherein the first element is mounted on the module housing so that, in the initial position of the first element, the passage opening is arranged such that it does not overlap with the outflow opening, and therefore the first element covers the outflow opening in order to close the outflow opening, and in that, in order to open the outflow opening, the passage opening is brought to overlap with the outflow opening when the first element moves out of its initial position into its end position.

13. The airbag module of claim 1, wherein the second element has at least one passage opening.

14. The airbag module of claim 13, wherein the second element is mounted on the module housing such that, in the initial position of the second element, the passage opening of the second element is arranged such that it at least partially overlaps with the outflow opening, and therefore the outflow opening is opened when the first element is moved out of its initial position into its end position.

15. The airbag module of claim 14, wherein the second element is mounted on the module housing such that the passage opening of the second element is brought by the movement of the second element out of its initial position into its end position such that it does not overlap with the open outflow opening, and therefore, in its end position, the second element covers the outflow opening in order to close the outflow opening.

16. The airbag module of claim 13, wherein the second element is mounted on the module housing such that, in the initial position of the second element, the passage opening of the second element is arranged such that it overlaps with the through-flow opening, and therefore gas generated by the gas generator can pass through the through-flow opening into the airbag, and in that, when the second element moves out of its initial position into its end position, the passage opening is brought such that it does not overlap with the through-flow opening in order to close the through-flow opening.

17. The airbag module of claim 1, wherein the outflow opening is formed in a wall part of the module housing.

18. The airbag module of claim 17, wherein the first element is mounted displaceably on the wall part of the module housing.

19. (canceled)

20. (canceled)

21. (canceled)

22. The airbag module of claim 17, wherein the first element is mounted displaceably on an inner side of the wall part, which inner side faces an interior space which is surrounded by the module housing.

23. The airbag module of claim 22, wherein the second element is mounted displaceably on the wall part.

24. (canceled)

25. (canceled)

26. The airbag module of claim 23, wherein the module housing has a chamber that at least partly surrounds the gas generator.

27. The airbag module of claim 26, wherein two walls that lie opposite each other transversely with respect to a main direction of deployment of the airbag protrude from the chamber.

28. The airbag module of claim 27, wherein the wall part is arranged on one of the two walls.

29. (canceled)

30. (canceled)

31. (canceled)

32. The airbag module of claim 28, wherein the two walls are part of a further chamber of the module housing that is in fluid communication with the chamber via the at least one through-flow opening and that forms a receptacle for the airbag.

33. (canceled)

34. The airbag module of claim 32, wherein the airbag has an inflow opening through which gas released by the gas generator can pass into the airbag.

35. (canceled)

36. The airbag module of claim 32, wherein the at least one through-flow opening is formed in a further wall part of the module housing.

37. The airbag module of claim 36, wherein the second element is mounted displaceably on the further wall part of the module housing.

38. (canceled)

39. (canceled)

40. (canceled)

41. (canceled)

42. The airbag module of claim 36, wherein the further wall part forms part of the chamber such that the further wall part is arranged along a main direction of deployment of the airbag between the gas generator and the airbag.

43. (canceled)

44. The airbag module of claim 37, wherein the first element is assigned a first movement-generating device that moves the first element out of its initial position into its end position.

45. The airbag module of claim 44, wherein the first movement-generating device moves the assigned first element out of its initial position into its end position at a predefinable opening time.

46. The airbag module of claim 45, wherein the opening time is calculated by an electronic control unit as a function of at least one parameter which can be sensed by a sensor unit.

47. (canceled)

48. The airbag module of claim 46, wherein the second element is assigned a second movement-generating device that moves the second element out of its initial position into its end position.

49. The airbag module of claim 48, wherein the second movement-generating device moves the assigned second element out of its initial position into its end position at a predefinable closing time.

50. The airbag module of claim 49, wherein the closing time is calculated by the electronic control unit as a function of at least one parameter that can be sensed by a sensor unit.

51. (canceled)

52. The airbag module of claim 48, wherein the first movement-generating device is arranged on the wall part.

53. The airbag module of claim 52, wherein the second movement-generating device is arranged on the wall part.

54. The airbag module of claim 53, wherein the two movement-generating devices lie opposite each other along the first direction of movement.

55. The airbag module of claim 52, wherein the second movement-generating device is arranged on the further wall part.

56. The airbag module of claim 54, wherein the wall part together with the two movement-generating devices and the two elements forms a pre-assembled lower module.

57. The airbag module of claim 52, wherein the wall part together with the first movement-generating device and the first element forms a pre-assembled first lower module.

58. The airbag module of claim 55, wherein the further wall part together with the second movement-generating device and the second element forms a pre-assembled second lower module.

59. (canceled)

60. (canceled)

61. (canceled)

62. (canceled)

63. (canceled)

64. (canceled)

65. (canceled)
